(19) United States
(12) Patent Application Publication
(10) Pub. No.: US 2023/0336517 A1
(43) Pub. Date: Oct. 19, 2023

(54) LIMITING UNWANTED INTERACTIONS

(71) Applicant: Facebook, Inc., Menlo Park, CA (US)

(72) Inventors: Mindi Yuan, Palo Alto, CA (US); Lauren Wong, San Francisco, CA (US); Katherine Liu, Los Altos, CA (US); Hitomi Dolly Hayashi-Branson, Mountain View, CA (US); Luqian Wang, Cupertino, CA (US); Samuel James Parker, San Francisco, CA (US)

(21) Appl. No.: 17/523,289

(22) Filed: Nov. 10, 2021

(51) Int. Cl. H04L 29/06; H04L 12/58

(52) U.S. Cl. CPC H04L 51/32; H04L 51/12; H04L 63/10

(57) ABSTRACT

Techniques for limiting unwanted comments are described. For example, a social networking system may receive, from a first account of the social networking system, a request to post content. In some examples, the social networking system may further receive an instruction to limit an ability of certain accounts lacking a characteristic from commenting on the first account’s content. In some cases, the social networking system may receive, from a second account. Upon determining that the second account lacks the characteristic, the social networking system may refrain from sharing the comment with one or more additional users.

### BACKGROUND

Digital platforms such as text messaging, instant messaging, email, social media, gaming, or other applications by which users can share content provide users with numerous benefits and opportunities. For instance, users may share information, media, and other types of content with family, friends, colleagues, and even strangers. In turn, other users may reply to and comment on such content, providing an opportunity to interact and engage in open dialogue. However, the freedom associated with sharing and commenting on content via these digital platforms is not without problems. For example, other users may respond to content in an offensive manner, such as responding with insults, hate speech, threats, violence, and so forth, either publicly or to specific users. In some instances, the offensive comments directed towards specific content may quickly escalate, often resulting in mass harassment. Thus, controlling how and whether offensive content is shared on digital platforms may present challenges.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement example techniques described herein.

FIGS. 2A-2D illustrate example interfaces for limiting sharing of comments by an account lacking a characteristic.

FIGS. 3A and 3B illustrate example interfaces usable to determine a period of time for which to limit sharing of comments by an account lacking a characteristic.

FIGS. 4A-4C illustrate example interfaces usable to present selectable controls to approve and delete comments on a post and block accounts.

FIGS. 5A-5C illustrate example interfaces usable to view a quarantine interface of comments received from accounts lacking the characteristic.

FIG. 6 illustrates an example process for limiting sharing of comments by an account lacking a characteristic.

FIG. 7 illustrates an example system and device which may be used to implement the techniques described herein.

### DETAILED DESCRIPTION

As discussed above, controlling whether and how offensive content is shared on digital platforms may present challenges. For instance, accounts on digital platforms may share content with other accounts, who may easily respond to the content with comments. In some cases, comments may be offensive comments, such as threats, hate speech, degrading or shaming an individual, sharing personal information, and repeated, unwanted messages, to name a few examples. Offensive comments can have negative, serious, and lasting consequences for the person sharing the comment, the person who posted the content to which the comment pertains, as well as other consumers of that content. By way of example and not limitation, consequences of such offensive comments can include hurt feelings, reputational damage, and in more extreme cases legal consequences, depression, substance abuse, and suicide.

In some cases, offensive comments may escalate quickly in scale. For instance, accounts with high visibility on social networking systems (e.g., influencers, artists, celebrities, athletes, to name a few) may be subject to heightened scrutiny due to their status and popularity. In some examples, accounts sharing content related to controversial issues (e.g., politics, abortion, vaccine mandates, etc.) may receive more engagement due to the controversial nature of their content. When such accounts and content are shared, the number of other accounts commenting negatively on the content may rapidly increase, resulting in mass harassment. In some cases, such harassment may be directed at the account who shared the content, while in other cases harassment may be directed at the other accounts commenting on the content. Accounts may wish to limit some offensive comments from being associated with their content, while still being able to engage with those accounts who are commenting positively.

Existing options for controlling whether and how offensive comments are shared on digital platforms have been inadequate. For instance, current techniques include providing the content creator the ability to remove selected comments. While this technique allows content creators the ability and freedom to decide which comments they deem offensive, this technique is ineffective in instances of mass harassment because the content creator simply cannot review nor keep up with the sheer number of comments being posted in real time. In another example, current techniques include providing the content creator the ability to limit all accounts from commenting. In such cases, while the content creator may guarantee the omission of all offensive comments, this technique restricts all comments- both offensive and harmless. Thus, the content creator is prevented from interacting with those other accounts commenting in a non-offensive manner, thereby diminishing the value of the digital platform.

This application describes techniques for allowing content creators who are experiencing or may experience mass harassment the ability to limit negative comments from other accounts while still maintaining the ability to engage with other accounts they wish to interact with. For instance, the techniques described herein may include refraining from sharing comments posted by accounts lacking one or more characteristics with the other accounts. Additionally or alternatively, comments from accounts lacking the one or more characteristics may be placed in a separate location and not presented with other comments associated with the content.

For instance, consider a first example where a first account is posting content which is shared on a social networking system. Based in part on the first account’s status and the nature of the content, the first account may believe that she is likely to receive mass harassment and bullying from other accounts. To curb such bullying, the first account may decide to limit the ability of accounts lacking a certain characteristic from commenting on her content. The characteristic may be based upon, for example, the other account being a follower of the first account, the other account following the first account within a threshold period of time (e.g., one day, five days, one week, etc.), a number of comments associated with the content, a number of followers of the first account, whether the other account is a friend or connection of the first account on the social networking system, to name a few examples. Upon receiving a comment from an account lacking the characteristic, such comment may be restricted from being shared with other accounts (e.g., the social networking system may refrain from sharing the comment with other accounts). Additionally, the comment from accounts lacking the characteristic may be placed in a separate, quarantine location and not presented with other comments associated with the content. The user of the first account may choose when or if to access comments in the quarantine location. Thus, comments may be shared or restricted from other accounts based in part on whether the account posting that comment meets certain criteria. In this way, the techniques described herein may reduce instances of mass harassment, improve relationships, encourage creativity, and so forth.

Various examples of the present disclosure include systems, methods, and non-transitory computer-readable media of a social networking system. In some examples, a social networking system may receive, from a first account of the social networking system, a request to post content. Posting content may take a variety of forms, such as a profile or feed post, a story, a direct message to one or more other users, a tweet, or a snap, to name a few examples. The social networking system may receive an instruction to limit the ability of accounts lacking a characteristic from commenting on the content. The characteristic may be indicative of whether another account is likely to leave a harmful or offensive comment on the content, subjecting the first account to harassment. For example, the characteristic may be based upon the other account being a follower of the first account or the other account following the first account for a threshold period of time (e.g., one day, five days, one week, one month, etc.).

Additionally or alternatively, the social networking system may determine that the content and/or the first account is currently experiencing, or is predicted to experience, mass harassment. The social networking system may prompt the first account to take proactive measures to prevent such mass harassment from occurring or stop further harassment. In some examples, the social networking system may employ one or more algorithms, filters, or models to identify potentially controversial content (e.g., content associated with religion, politics, etc.). The algorithms, filters, or models may be based on text, audio, and/or video of the content. In some examples, the social networking system may employ a machine-learned model trained to detect content that is likely to encounter mass harassment.

Additionally or alternatively, the social networking system may determine that one or more characteristics of the first account make it more likely to encounter mass harassment. For instance, characteristics of the first account that may make it more susceptible to mass harassment include, without limitation, a number of followers, friends, or contacts associated with the first account (e.g., accounts with more followers tend to be more likely to be victims of mass harassment), a change in rate of followers friends, or contacts associated with the first account (e.g., accounts that experience above average or above historical rates of increase of followers can indicate that the recent publicity notoriety and tend to be more likely to experience mass harassment), a change in account status of the first account (e.g., from private to public), an increase in frequency that the first account is recommended to other accounts by the social networking system, a mention of the first account by another account with a large number of followers, etc.

The social networking system may further receive, from a second account which lacks the characteristic, a comment associated with the content. Similar to the content, the comment may be a response to a profile or feed post, a response to a story, or a direct message response, to name a few examples. The social networking system may then refrain from sharing the comment with the one or more additional accounts such that the comment may not be accessible or visible to those additional accounts. For instance, upon accessing the content, the other accounts may not be able to see and/or interact with the comment by the second account. In some instances, on the interface of the first account, the comment by the second account may be placed in separate location (e.g., a quarantine location) such that the comment is not presented with other comments associated with the content. Instead, in that case, the user of the first account may choose when or if to access comments in the quarantine location. However, in some instances, the comment may still be visible to the second account (e.g., the fact that the comments have been limited by the first account may not be visible to the second account).

In some examples, the comment is a first comment. The social networking system may then receive a third comment having the characteristic and associated with the content. Upon receiving the third comment, the social networking system may share the second comment with the one or more additional accounts.

In some examples, the characteristic includes following the first account for a period of time greater than a threshold period of time. For example, the social networking system may determine a threshold period of time (e.g., one day, five days, one week, one month, etc.). Upon determining that the second account has followed the first account for greater than the threshold period of time, the social networking system may determine that the second account has the characteristic. Conversely, determining that the second account has not followed the first account for the threshold period of time may indicate that the second account lacks the characteristic.

In some examples, the instruction to limit the ability of accounts lacking the characteristic from commenting on the content can be set for a specified period of time. For example, the first account may anticipate that for a period of time following posting the content, other accounts may be more likely to comment on the content, increasing the chances the first account may encounter harassment. Thus, the first account may designate a period of time (e.g., one day, two days, one week, one month, etc.) to limit the ability of accounts lacking the characteristic from commenting on the content. In some examples, the specified period of time may be a default period of time specified by the social networking system. In some examples, once the period of time has passed, the first account may allow accounts lacking the characteristic to comment on the content. In some examples, once the period of time has passed, the first account may be prompted whether to extend the limited comment period or whether to turn off the limited comment period.

In some examples a determination whether an account lacks the characteristic may be made at a time the instruction to limit an ability of accounts lacking a characteristic from commenting on the content. For example, an account may lack the characteristic when the first account designates a period of time. However, before the period of time elapses, the account lacking the characteristic may obtain the characteristic. In some examples, once the account lacking the characteristic obtains the characteristic, the social networking system may share a comment from the account previously lacking the characteristic. Alternatively, the social networking system may continue to refrain from sharing comments by the account previously lacking the characteristic until the period of time has elapsed.

In some examples, the instruction to limit the ability of accounts lacking the characteristic from commenting on the content is based in part on input received by the first account. In other words, the first account may decide when to limit the ability of accounts lacking the characteristic from commenting. Additionally or alternatively, the user of the first account may determine and specify which characteristics to use when determining the ability to allow accounts to comment, such as a number of mutual followers an account has, or whether the first account has previously interacted with the account, to name a few examples.

In some examples, the instruction to limit the ability of accounts lacking the characteristic from commenting on the content is received from the social networking system. The characteristic may be based in part on an offensiveness of the comment, a number of comments associated with the content, a number of followers of the first account, or an increased rate in followers of the first account, to name a few examples.

In some examples, the social networking system may refrain from presenting the comment to the first account in association with the content. For instance, the first account may view the content and comments associated with the content. However, comments received from accounts that lack the characteristic (e.g., accounts that do not follow the first account or have followed the first account for less than a threshold amount of time) may not be initially visible to the first account. Rather, in some examples, the social networking system may send the comment to a separate location, such as separate quarantine interface. The quarantine interface may be accessible by the first account. Additionally or alternatively, the quarantine interface may be separate from other comments associated with the content. Thus, in instances in which there is a large number of comments, the first account may be able to view comments from other accounts who have the characteristic, without having to view potentially harmful and offensive comments by accounts lacking the characteristic. In other words, the first account may be able to interact with the accounts they wish to interact with, while not being subject to harassment.

In some examples, the social networking system may present, to the first account, a control associated with at least approving or deleting the comment. In some examples, the control associated with approving or deleting the comment may be accessible from within the quarantine interface. Upon selection of the approval control by the first account, the social networking system may share the comment with the one or more additional accounts. Conversely, upon selection of the delete control by the first account, the social networking system may refrain from sharing the comment with the one or more additional accounts. In some examples, deleting the comment may permanently delete the comment from the first user account, while in other examples, the first account may later choose to approve the comment.

In some examples, the social networking system may present, to the first account, a control associated with blocking the comment. Based in part on receiving input via the control blocking the comment, the social networking system may refrain from sharing additional comments by the second account with the one or more additional accounts. In some examples, receiving input to block the comment may further include refraining from sharing additional comments by the second account associated with any content by the first account.

In some examples, the comment may be a first comment. The social networking system may further receive a second comment in response to the first comment. In other words, the first comment may be a parent comment while the second comment may be a child comment. In some instances, the social networking system may receive, from the first account, an indication to approve the second comment. Upon receiving the indication, the social networking system may share, with other accounts, the first comment and the second comment.

In some examples, the content comprises at least a portion of a profile post, a story, or a direct message.

These techniques allow accounts posting content the ability and freedom to share their thoughts and opinions without fear of being subjects of mass harassment. By limiting which comments are shared on the social networking system, accounts sharing content are afforded the flexibility to interact with other accounts commenting in a non-offensive manner, without being subject to offensive and hurtful comments.

These and other aspects are described further below with reference to the accompanying drawings. The drawings are merely example implementations, and should not be construed to limit the scope of the claims. For example, while examples are illustrated in the context of a user interface for a mobile device, the techniques may be implemented using any computing device and the user interface may be adapted to the size, shape, and configuration of the particular computing device. Also, while many of the examples are given in the context of offensive content, the techniques described herein may also be applied to, without limitation, aggressive content, threatening content, sexual content, abusive content, obscene content, or any other content that is objectionable to a user, with machine-learned models being trained to detect any or all of these types of content.

### Example System Architecture

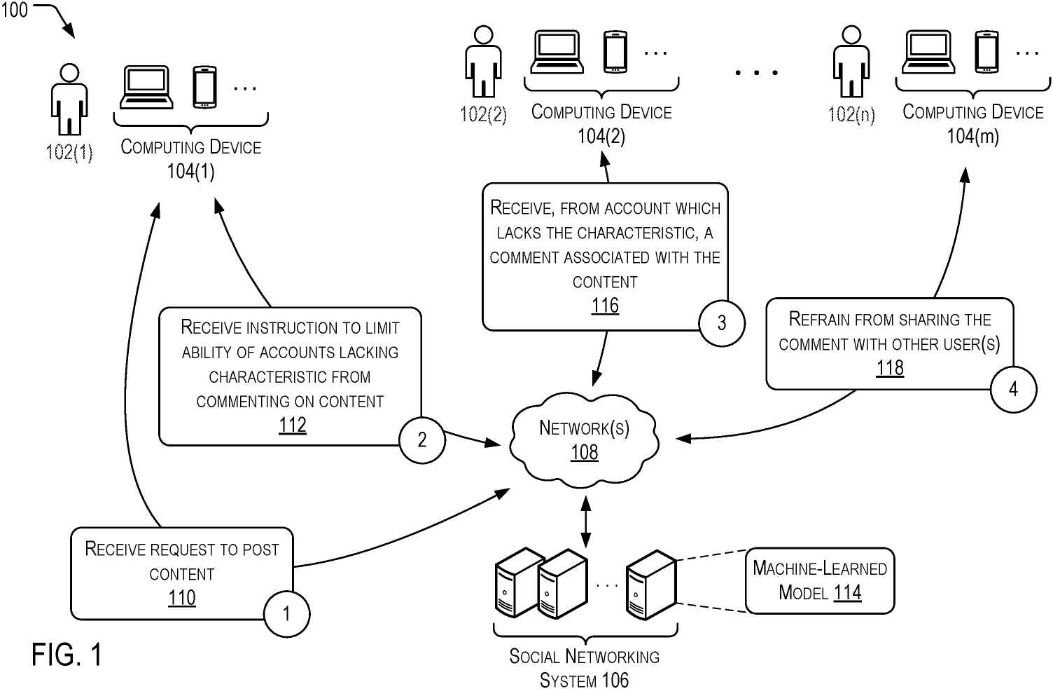

FIG. 1 is a schematic view of an example computing system 100 usable to implement example techniques described herein to limit unwanted comments. In some examples, the computing system 100 may include accounts 102(1), 102(2), ... 102(n) (collectively “accounts 102”) that are associated with users and interact using computing devices 104(1), 104(2), ... 104(m) (collectively “computing devices 104”) with a social networking system 106 via a network 108. In this example, n and m are non-zero integers greater than 1.

Each of the computing devices 104 includes one or more processors and memory storing computer executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), wearable devices (e.g., augmented reality or virtual reality devices, glasses, watches, etc.), or other suitable computing devices. The computing devices 104 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the social networking system 106 and/or communicate with one another.

The social networking system 106 may include one or more servers or other computing devices, any or all of which may include one or more processors and memory storing computer executable instructions to implement the functionality discussed herein attributable to the social networking system 106 or digital platform. The social networking system 106 may enable accounts 102 associated with its users (such as persons or organizations) to interact with the social networking system 106 and with each other via the computing devices 104. The social networking system 106 may, with input from a user, create and store in the social networking system 106 a user account associated with the user. The user account may include demographic information, communication-channel information, financial information and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the accounts 102.

The social networking system 106 may be configured to limit offensive and harassing comments from some accounts while still maintaining the ability to engage with other accounts an account posting content may wish to interact with. For example, at operation 110 (indicated by “1”), the social networking system 106 may receive, from a first account 102(1), a request to post content to the social networking system 106. In some examples, the first account 102(1) may initiate sharing of content from the first account 102(1) to one or more of the other accounts of the social networking system 106.

Sharing content may take a variety of forms, such as a profile or feed post, a story, a direct message to one or more other accounts, a tweet, or a snap, to name a few examples. In general, a profile (or feed) post may include text and/or media content items, such as images, video, and/or audio. The profile post may be published to the social networking system 106 by an account, such as the first account 102(1), for consumption by other accounts 102(2) - 102(n), and may be viewable by the other accounts 102(2) - 102(n) for as long as the first account 102(1) is active and/or until the post is deleted by the first account 102(1), although examples are considered in which the profile post is removed and/or deleted after an amount of time (e.g., one hour, one day, one week, etc.). In some cases, a profile post shared by the first account 102(1) may be included in respective content feeds of other the accounts 102(2) - 102(n) of the social networking system 106 that have “followed” the first account 102(1), are “friends” with the first account 102(1), are connections of the first account 102(1), or are otherwise associated with the account 102(1).

A story may be similar to a profile post, in that the story may include text and/or media content items, such as images, video, and/or audio, is published to the social networking system 106 by the first account 102(1) for consumption by the other accounts 102(2) - 102(n), and may be included in a feed (although, in some cases, a separate feed from the profile post feed). However, a story may differ from a profile post in that the story may be shared only with a selected subset of the first account’s 102(1) followers, and/or may be removed from being viewed by followers of the first account 102(1) after a certain period of time (e.g., one hour, one day, one week, etc.). A direct message may also include text and/or media content items, such as images, video, and/or audio, but in general, a direct message is shared with a single other account 102(n) of the social networking system 106, or a selected subset of other accounts 102(2) - 102(n) of the social networking system 106 rather than shared with all of an account’s 102 followers.

At operation 112 (indicated by a “2”), the social networking system 106 may receive an instruction to limit an ability of accounts lacking a characteristic from commenting on the content. As discussed further below, the instruction may be received the first account 102(1) (e.g., based on user input) and/or from the social networking system 106. The characteristic may be indicative of a likelihood of other accounts to leave a disparaging or harassing comment on the content, with accounts lacking the characteristic tending to be more likely to leave a disparaging or harassing comment than accounts having the characteristic. For example, the characteristic may be based upon the other account 102(n) being a follower of the first account 102(1), or the other account 102(n) following the first account 102(1) for a threshold period of time (e.g., 1 day, 5 days, 1 week, 1 month, etc.). For instance, the social networking system 106 may determine a period of time that the other account 102(n) has followed the first account 102(1). Determining that the period of time the other account 102(n) has followed the first account 102(1) is greater than or equal to the threshold time may indicate that the other account 102(n) has the characteristic, while determining that the period of time the other account 102(n) has followed the first account 102(1) is less than the threshold time may indicate that the other account lacks the characteristic. Thus, because other accounts 102(2) - 102(n) who have followed the first account 102(1) for a period of time may be more likely to be friends with or personally know the first account 102(1) as opposed to accounts who do not follow the first account 102(1), there may be a chance that the followers of the first account 102(1) are less likely to engage in harassment as opposed to accounts that do not follow the first account 102(1).

In some examples, the social networking system 106 may receive the instruction from the first account 102(1). For example, the first account 102(1) may desire to post content regarding a controversial topic. Due to the nature of the content, the first account 102(1) may believe that their account is likely to receive harassment. For example, the content may be regarding a controversial topic, such as politics or reproductive rights. In order to curb such harassment, the first account 102(1) may choose to limit the ability of other accounts from commenting on the first account’s 102(1) content. Additionally or alternatively, the first account 102(1) may choose the one or more characteristics (e.g., a number of mutual followers the other account 102(n) has, whether the first account 102(1) has previously interacted with the other account 102(n), etc.), providing the first account 102(1) with the flexibility to determine which accounts 102(n) they believe are more likely to leave unwanted comments on their content.

Additionally or alternatively, the social networking system 106 may determine that the content and/or the first account 102(1) is currently experiencing, or is predicted to experience, mass harassment. The social networking system 106 may prompt the first account 102(1) to take proactive steps to prevent such mass harassment from occurring or take measures to stop currently occurring mass harassment. For example, the social networking system 106 may implement one or more algorithms, filters, or models to identify potential controversial content. For instance, the algorithms, filters, or models may be based on text, audio, and/or video on the content. The algorithms, filters, or models may be trained to analyze the content to detect potentially controversial content, such as that associated with religion or politics, to name a few examples.

Additionally or alternatively, the social networking system 106 may determine that one or more characteristics of the first account 102(1) make it more susceptible to experiencing mass harassment. These characteristics may include, to name a few non-limiting examples, a number of followers, friends, or contacts associated with the first account 102(1) (e.g., accounts with a larger number of followers tend to be associated with celebrities, rendering them more susceptible to harassment), a change in an account status of the first account 102(1) (e.g., from private to public or from unverified to verified), an increase in frequency that the first account 102(1) is shared with other accounts 102(n) by the social networking system 106 as recommended accounts, a tag of the first account 102(1) by another account 102(n) with a large number of followers, etc.

By way of example, the social networking system 106 may receive the instruction from a machine-learned model 114 of the social networking system 106. For instance, the social networking system 106 may input the content into the machine-learned model trained to detect content that is likely to encounter mass harassment and/or accounts that are likely to encounter mass harassment events. In some examples, the machine-learned model 114 may build a mathematical model using training data that includes content that has been the target of mass harassment, such as bullying, hate speech, taunting, and so forth. Thus, the machine-learned model 114 may make predictions on future content on whether that content is likely to experience harassment, without the machine-learned model 114 being explicitly programmed to detect such content.

The machine-learned model 114 may take a variety of forms. For instance, the machine-learned model 114 may be a text classifier trained to identify content that may be encounter harassment. The text classifier, in some examples, may be an artificial neural network trained to detect text that is likely to provoke harassment, such as content containing controversial topics such as politics, abortions, and vaccine mandates, to name a few examples. For example, the machine-learned model 114 may receive the content from the first account 102(1) and using keywords (e.g., Biden, Roe v. Wade, Pfizer, etc.), output a score associated with the content indicative of a potential harassment level (e.g., a likelihood that the content will encounter mass harassment) of the content. Based in part on the score being greater or equal to a threshold score, the machine-learned model 114 may determine that the content may be subject to mass harassment.

Accordingly, the machine-learned model 114 may include a number of classifiers to analyze the different content types received from the first account 102(1). As another example, the machine-learned model 114 may include an artificial neural network including a computer vision classifier trained to analyze images and/or video (e.g., a frame and/or frames of a video) for images that may be subject to mass harassment. Additionally or alternatively, the machine-learned model 114 may include an artificial neural network including a speech recognition classifier trained to analyze speech or other audio included in a video or audio recording for harassment-inducing speech. Further, the machine-learned model 114 may include an optical character recognition (OCR) classifier, which when given an image representing printed text (e.g., in a GIF, sticker, characters traced onto a touch screen using a finger or stylus, etc.), determines the corresponding text. The OCR classifier may output the text to a text classifier trained to identify potentially harassment-inducing text, as described above.

In some examples, the machine-learned model 114 may determine that the content and/or the first account 102(1) may be subject to mass harassment, and may output a prompt to the first account 102(1) to turn on a feature to limit commenting by certain types of accounts (e.g., non-followers and/or recent followers), thereby allowing the first account 102(1) to take proactive measures to prevent such mass harassment from occurring. This determination may be based in part on the first account 102(1) and/or the content, and whether the first account 102(1) has already shared the content to the social networking system 106.

For instance, consider an example in which the first account 102(1) has requested to post content, but has yet to share the content with other accounts 102(2) - 102(n) of the social networking system 106. The machine-learned model 114 may determine the first account 102(1) may encounter mass harassment based in part on a number of followers of the first account 102(1). In other words, the more followers the first account 102(1) has, the more popular and well-known the first account 102(1) may be, subjecting the first account 102(1) to higher visibility and scrutiny by other accounts 102. For example, the machine-learned model 114 may determine a number of followers of the first account 102(1) (e.g., 100,000 followers, 1 million followers, 5 million followers, etc.). Based in part on the number of followers being greater or equal to the threshold number of followers (e.g., 500k followers, 1 million followers, 2 million followers, etc.), the machine-learned model 114 may determine that the first account 102(1) is likely to encounter mass harassment.

In some examples, the machine-learned model 114 may determine the first account 102(1) may be subject to mass harassment based in part on an increased rate of change of followers. In other words, a rapid increase in followers may indicate that the first account 102(1) is trending or becoming popular and will likely be viewed by a growing audience, thus more likely to be subject to mass harassment.

For example, the machine-learned model 114 may determine a historical average rate of change of followers of the first account 102(1). The average rate of change of followers may represent the percent increase or decrease of new followers of the first account 102(1) over a period of time. As such, the historical average rate of change of followers may represent the percent increase or decrease of followers of the first account 102(1) over a period of time the first account 120(1) has been active (e.g., past 6 months, past 1 year, past 2 year, etc.). The machine-learned model 114 may then determine a recent average rate of change of followers over a recent period of time (e.g., the past week, the past 2 weeks, the past month, etc.). The machine-learned model 114 may compare the recent average rate of change of followers to the historical rate of change of followers to determine an overall rate of change of followers. The machine-learned model 114 may compare the overall rate of change of followers to a threshold rate of change of followers (e.g., +10% increase, +50% increase, +100% increase, +1,000% increase) and, upon determining that the overall rate of change of followers exceeds the threshold or historical rate of change of followers, the machine-learned model 114 may determine that the first account 102(1) is likely to encounter mass harassment.

In some examples, the machine-learned model 114 may analyze content that has already been posted by the first account 102(1) to the social networking system 106 to determine if the first account 102(1) is experiencing or is likely to experience mass harassment. For example, similar to determining an overall rate of change of followers to determine that the first account 102(1) is likely becoming popular or going viral, the machine-learned model 114 may analyze the posted content to determine whether the content is likely becoming popular or going viral, thus making it more likely the content may be subject to mass harassment.

For example, the machine-learned model 114 may determine a historical average rate of change of engagement with the content. The average historical rate of change of engagement may be based in part on the number of likes, comments, saves, or shares of the content, to name a few non-limiting examples, over a period of time the content has been posted to the social networking system 106 (e.g., one hour, six hours, one day, one week, etc.). The machine-learned model 114 may then determine a recent rate of change of engagement over a recent period of time (e.g., the past 10 minutes, the past 30 minutes, the past hour, the past day, etc.). The machine-learned model 114 may compare the recent average rate of change of followers to the historical rate of change of followers to determine an overall rate of change of followers. The machine-learned model 114 may then compare the overall rate of change of engagement to a threshold rate of change of engagement (e.g., +10% increase, +50% increase, +100% increase, +1,000% increase) and upon determining that the overall rate of change of engagement exceeds the threshold or historical rate of change of engagement, the machine-learned model 114 may determine that the content posted by the first account 102(1) is likely to experience mass harassment.

Upon detecting the first account 102(1) and/or the content is experiencing or is likely to experience mass harassment, the social networking system 106 may prompt the first account 102(1) to send an instruction to limit the ability of accounts lacking the characteristic from commenting on the post. In this way, the social networking system 106 may allow the first account 102(1) to take proactive measures to protect itself from experiencing mass harassment or experiencing further harassment.

Although specific machine-learned models are described above, other types of machine-learned models can additionally or alternatively be used. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

At operation 116 (indicated by a “3”), the social networking system 106 may receive, from a second account 102(2) lacking the characteristic, a comment associated with the content. For example, the second account 102(2) may not follow the first account 102(1), but nonetheless access the first account’s 102(1) content and leave a response to that content.

At operation 118 (indicated by a “4”), the social networking system 106 may refrain from sharing the comment with one or more additional accounts 102(3) - 102(n). In other words, while the second account 102(2) may comment on the first account’s 102(1) content, that comment may not be visible to the additional accounts 102(3) - 102(n) viewing the content. However, in some examples, the comment may still be visible to the second account 102(2).

As an illustrative example, the characteristic may be based in part on another account 102 being a follower of the first account 102(1). The second account 102(2) may then comment on the first account’s 102(1) content. Upon receiving the comment, the social networking system 106 may determine that the second account 102(2) is not a follower of the first account 102(1). Based in part on the social networking system 106 determining that the second account 102(2) is not a follower of the first account 102(1), and therefore lacking the characteristic, the social networking system 106 may refrain from sharing the comment with the one or more additional accounts 102(3) - 102(n).

In some examples, the instruction to limit the ability of accounts 102 lacking the characteristic from commenting on the content may be for a specified period of time. For example, the first account 102(1) may anticipate an initial wave of mass harassment upon posting controversial content. While the first account 102(1) may wish to initially limit mass harassment associated with the content, the first account 102(1) may not wish to permanently limit the ability for other accounts 102(2) - 102(n) to comment. For example, the first account 102(1) may anticipate that for a period of time following posting the content (e.g., one day, two days, one week), other accounts 102(2) - 102(n) may be more likely to make comments associated with the content. However, the longer that the content has been shared, the more likely it may be that new content from other accounts 102(2) - 102(n) are the new targets of mass harassment, rendering it less likely that the first account 102(1) will still be subject to mass harassment. As such, the first account 102(1) may designate a period of time (e.g., one day, two days, one week, one month, etc.) to limit the ability of accounts 102(2) - 102(n) lacking the characteristic from commenting on the content. Conversely, the social networking system 106 may designate a default period of time. Once the period of time has passed, the first account 102(1) may, in some examples, be prompted by the social networking system 106 whether to extend the limited comment period or whether the turn off the limited comment period.

In some examples, the first account 102(1) may choose to approve or delete comments associated with the content. For instance, upon the first account 102(1) accessing the comment associated with the content, the social networking system 106 may present to the first account 102(1) controls associated with at least approving and/or deleting the comment. Upon selecting the control associated with approving the comment, the comment may be accessible for the additional accounts 102(3) - 102(n) to view. Conversely, upon selecting the control associated with deleting the comment, the comment may be refrained from being shared with the additional accounts 102(3) - 102(n). In some examples, upon deleting the comment, the second account 102(2) may still view the comment, while in other examples, deleting the comment may remove the comment from the second account’s 102(2) view. Furthermore, the deletion may be a permanent deletion from the first user account 102(1); however, in other examples, the first account 102(1) may later choose to approve the comment.

In this way, the first account 102(1) is afforded greater flexibility in determining which comments they deem to constitute harassment, therefore hiding such comments from the additional accounts, and which comments they deem to be appropriate to share with other accounts.

In some examples, the first account 102(1) may choose to block the second account 102(2). For instance, upon the first account 102(1) accessing the comment associated with the content, the social networking system 106 may present to the first account 102(1) controls associated with blocking the second account 102(2), similar to the controls associated with approving and deleting the comment. Upon selection of the control associated with blocking the second account 102(2), the social networking system 106 may refrain from sharing future comments by the second account 102(2). In some examples, the social networking system 106 may refrain from sharing future comments by the second account 102(2) associated with the content, while in other examples, the social networking system 106 may refrain from sharing future comments by the second account 102(2) associated with any content by the first account 102(1). Furthermore, the block may be permanent; however, in other examples, the first account 102(1) may later choose to unblock the second account 102(2), allowing the second account 102(2) to share future comments.

In some examples, sharing the comment may be based in part on whether the comment is in response to another comment. For example, the comment by the second account 102(2) may be a first comment. The social networking system 106 may then receive a second comment in response to the first comment, rendering the first comment a parent comment and the second comment a child comment. In some instances, the first account 102(1) may send, to the social networking system 106, an indication to approve the second, child comment. Upon receiving the indication, the social networking system 106 may share both the second child comment and the first parent comment with the additional accounts 102(3) - 102(n). In other words, approving a child comment may also approve the parent comment.

In some examples, the social networking system 106 may send the comment to a separate location, such as a quarantine interface. For instance, the quarantine interface may be accessible by the first account 102(1) and may be separate from other comments associated with the content, such that the comment is not present with other comments associated with the content. Instead, the first account 102(1) may choose when or if to access comments in the quarantine interface. In some instances, however, the content may still be visible to the second account 102(2). Thus, in instances in which there may be a large number of comments, the first account 102(1) may be able to view comments from other accounts who have the characteristic, without having to view potentially harmful and offensive comments by accounts lacking the characteristic.

In some examples, the social networking system 106 may provide privacy features to the accounts 102. In particular examples, one or more objects (e.g., content or other types of objects) of the computing system 100 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular account or other entity to access that object, the object may be described as being “visible” with respect to that account or other entity. As an example, and not by way of limitation, an account of the social networking system 106 may specify privacy settings for a account-profile page that identify a set of accounts that may access work-experience information on the account-profile page, thus excluding other accounts from accessing that information.

In particular examples, privacy settings for an object may specify a “blocked list” and/or a “restricted list” of accounts or other entities that should not be allowed to access certain information associated with the object. In particular examples, the blocked list may include third-party entities. The blocked list or restricted list may specify one or more accounts or entities for which an object is not visible. As an example, and not by way of limitation, an account may specify a set of accounts who may not access photo albums associated with the account, thus excluding those accounts from accessing the photo albums (while also possibly allowing certain accounts not within the specified set of accounts to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by accounts tagged in the photo and friends of the accounts tagged in the photo. In particular examples, privacy settings may allow accounts to opt in to or opt out of having their content, information, or actions stored/logged by the social networking system 106 or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other accounts of the online social network. Similarly, the privacy settings applied to a particular node may control whether the account or concept corresponding to the node is visible to other accounts of the online social network. As an example, and not by way of limitation, the first account 102(1) may share an object to the social networking system 106. The object may be associated with a concept node connected to an account node of the first account 102(1) by an edge. The first account 102(1) may specify privacy settings that apply to a particular edge connecting to the concept node of the object or may specify privacy settings that apply to all edges connecting to the concept node. As another example and not by way of limitation, the first account 102(1) may share a set of objects of a particular object-type (e.g., a set of images). The first account 102(1) may specify privacy settings with respect to all objects associated with the first account 102(1) of that particular object-type as having a particular privacy setting (e.g., specifying that all images posted by the first account 102(1) are visible only to friends of the first account 102(1) and/or accounts tagged in the images).

In particular examples, the social networking system 106 may present a “privacy wizard” (e.g., within a webpage, a module, one or more dialog boxes, or any other suitable interface) to the first account 102(1) to assist the first account 102(1) in specifying one or more privacy settings. The privacy wizard may display instructions, suitable privacy-related information, current privacy settings, one or more input fields for accepting one or more inputs from the first account 102(1) specifying a change or confirmation of privacy settings, or any suitable combination thereof. In particular examples, the social networking system 106 may offer a “dashboard” functionality to the first account 102(1) that may display, to the first account 102(1), current privacy settings of the first account 102(1). The dashboard functionality may be displayed to the first account 102(1) at any appropriate time (e.g., following an input from the first account 102(1) summoning the dashboard functionality, following the occurrence of a particular event or trigger action). The dashboard functionality may allow the first account 102(1) to modify one or more of the first account 102(1)′s current privacy settings at any time, in any suitable manner (e.g., redirecting the first account 102(1) to the privacy wizard).

Privacy settings associated with an object may specify any suitable granularity of permitted access or denial of access, including the “restrict” functionality described herein. As an example and not by way of limitation, access or denial of access may be specified for particular accounts (e.g., only me, my roommates, my boss), accounts within a particular degree-of-separation (e.g., friends, friends-of-friends), account groups (e.g., the gaming club, my family), account networks (e.g., employees of particular employers, students or alumni of particular university), all accounts (“public”), no accounts (“private”), accounts of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers may be authorization/privacy servers for enforcing privacy settings. In response to a request from an account (or other entity) for a particular object stored in a data store, the social networking system 106 may send a request to the data store for the object. The request may identify the account associated with the request and the object may be sent only to the account (or a client system of the account) if the authorization server determines that the account is authorized to access the object based on the privacy settings associated with the object. If the requesting account is not authorized to access the object, the authorization server may prevent the requested object from being retrieved from the data store or may prevent the requested object from being sent to the account. In the search-query context, an object may be provided as a search result only if the querying account is authorized to access the object, e.g., if the privacy settings for the object allow it to be surfaced to, discovered by, or otherwise visible to the querying account. In particular examples, an object may represent content that is visible to an account through a newsfeed of the account. As an example, and not by way of limitation, one or more objects may be visible to a account’s “Trending” page. In particular examples, an object may correspond to a particular account. The object may be content associated with the particular account or may be the particular account’s account or information stored on the social networking system 106, or other computing system. As an example, and not by way of limitation, a first account 102(1) may view one or more second accounts of an online social network through a “People You May Know” function of the online social network, or by viewing a list of friends of the first account 102(1). As an example, and not by way of limitation, a first account 102(1) may specify that they do not wish to see objects associated with a particular second account in their newsfeed or friends list. If the privacy settings for the object do not allow it to be surfaced to, discovered by, or visible to the account, the object may be excluded from the search results. Although this disclosure describes enforcing privacy settings in a particular manner, this disclosure contemplates enforcing privacy settings in any suitable manner.

In particular examples, different objects of the same type associated with an account may have different privacy settings. Different types of objects associated with an account may have different types of privacy settings. As an example, and not by way of limitation, a first account 102(1) may specify that the first account 102(1)′s status updates are public, but any images shared by the first account 102(1) are visible only to the first account 102(1)′s friends on the online social network. As another example and not by way of limitation, an account may specify different privacy settings for different types of entities, such as individual accounts, friends-of-friends, followers, account groups, or corporate entities. As another example and not by way of limitation, a first account 102(1) may specify a group of accounts that may view videos posted by the first account 102(1), while keeping the videos from being visible to the first account 102(1)′s employer. In particular examples, different privacy settings may be provided for different account groups or account demographics. As an example, and not by way of limitation, a first account 102(1) may specify that other account who attend the same university as the first account 102(1) may view the first account 102(1)′s pictures, but that other account who are family members of the first account 102(1) may not view those same pictures.

In particular examples, the social networking system 106 may provide one or more default privacy settings for each object of a particular object-type. A privacy setting for an object that is set to a default may be changed by an account associated with that object. As an example, and not by way of limitation, all images posted by a first account 102(1) may have a default privacy setting of being visible only to friends of the first account 102(1) and, for a particular image, the first account 102(1) may change the privacy setting for the image to be visible to friends and friends-of-friends.

In particular examples, privacy settings may allow a first account 102(1) to specify (e.g., by opting out, by not opting in) whether the social networking system 106 may receive, collect, log, or store particular objects or information associated with the account for any purpose. In particular examples, privacy settings may allow the first account 102(1) to specify whether particular applications or processes may access, store, or use particular objects or information associated with the account. The privacy settings may allow the first account 102(1) to opt in or opt out of having objects or information accessed, stored, or used by specific applications or processes. The social networking system 106 may access such information in order to provide a particular function or service to the first account 102(1), without the social networking system 106 having access to that information for any other purposes. Before accessing, storing, or using such objects or information, the social networking system 106 may prompt the account to provide privacy settings specifying which applications or processes, if any, may access, store, or use the object or information prior to allowing any such action. As an example, and not by way of limitation, a first account 102(1) may transmit a message to a second account via an application related to the online social network (e.g., a messaging app), and may specify privacy settings that such messages should not be stored by the social networking system 106.

In particular examples, an account may specify whether particular types of objects or information associated with the first account 102(1) may be accessed, stored, or used by the social networking system 106. As an example, and not by way of limitation, the first account 102(1) may specify that images sent by the first account 102(1) through the social networking system 106 may not be stored by the social networking system 106. As another example and not by way of limitation, a first account 102(1) may specify that messages sent from the first account 102(1) to a particular second account may not be stored by the social networking system 106. As yet another example and not by way of limitation, a first account 102(1) may specify that all objects sent via a particular application may be saved by the social networking system 106.

In particular examples, privacy settings may allow a first account 102(1) to specify whether particular objects or information associated with the first account 102(1) may be accessed from particular client systems or third-party systems. The privacy settings may allow the first account 102(1) to opt in or opt out of having objects or information accessed from a particular device (e.g., the phone book on an account’s smart phone), from a particular application (e.g., a messaging app), or from a particular system (e.g., an email server). The social networking system 106 may provide default privacy settings with respect to each device, system, or application, and/or the first account 102(1) may be prompted to specify a particular privacy setting for each context. As an example, and not by way of limitation, the first account 102(1) may utilize a location-services feature of the social networking system 106 to provide recommendations for restaurants or other places in proximity to the account. The first account 102(1)′s default privacy settings may specify that the social networking system 106 may use location information provided from a client device of the first account 102(1) to provide the location-based services, but that the social networking system 106 may not store the location information of the first account 102(1) or provide it to any third-party system. The first account 102(1) may then update the privacy settings to allow location information to be used by a third-party image-sharing application in order to geo-tag photos.

### Privacy Settings for Mood, Emotion, or Sentiment Information

In particular examples, privacy settings may allow an account to specify whether current, past, or projected mood, emotion, or sentiment information associated with the account may be determined, and whether particular applications or processes may access, store, or use such information. The privacy settings may allow accounts to opt in or opt out of having mood, emotion, or sentiment information accessed, stored, or used by specific applications or processes. The social networking system 106 may predict or determine a mood, emotion, or sentiment associated with an account based on, for example, inputs provided by the account and interactions with particular objects, such as pages or content viewed by the account, posts or other content uploaded by the account, and interactions with other content of the online social network. In particular examples, the social networking system 106 may use an account’s previous activities and calculated moods, emotions, or sentiments to determine a present mood, emotion, or sentiment. An account who wishes to enable this functionality may indicate in their privacy settings that they opt into the social networking system 106 receiving the inputs necessary to determine the mood, emotion, or sentiment. As an example, and not by way of limitation, the social networking system 106 may determine that a default privacy setting is to not receive any information necessary for determining mood, emotion, or sentiment until there is an express indication from an account that the social networking system 106 may do so. By contrast, if an account does not opt in to the social networking system 106 receiving these inputs (or affirmatively opts out of the social networking system 106 receiving these inputs), the social networking system 106 may be prevented from receiving, collecting, logging, or storing these inputs or any information associated with these inputs. In particular examples, the social networking system 106 may use the predicted mood, emotion, or sentiment to provide recommendations or advertisements to the account. In particular examples, if an account desires to make use of this function for specific purposes or applications, additional privacy settings may be specified by the account to opt in to using the mood, emotion, or sentiment information for the specific purposes or applications. As an example, and not by way of limitation, the social networking system 106 may use the account’s mood, emotion, or sentiment to provide newsfeed items, pages, friends, or advertisements to an account. The account may specify in their privacy settings that the social networking system 106 may determine the account’s mood, emotion, or sentiment. The account may then be asked to provide additional privacy settings to indicate the purposes for which the account’s mood, emotion, or sentiment may be used. The account may indicate that the social networking system 106 may use his or her mood, emotion, or sentiment to provide newsfeed content and recommend pages, but not for recommending friends or advertisements. The social networking system 106 may then only provide newsfeed content or pages based on account mood, emotion, or sentiment, and may not use that information for any other purpose, even if not expressly prohibited by the privacy settings.

### Privacy Settings for Ephemeral Sharing

In particular examples, privacy settings may allow an account to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, an account may specify that a particular image uploaded by the account is visible to the account’s friends for the next week, after which time the image may no longer be accessible to other accounts. As another example and not by way of limitation, a company may post content related to a product release ahead of the official launch and specify that the content may not be visible to other accounts until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of an account associated with the objects or information, and may subsequently delete the objects or information, as specified by the respective privacy settings. As an example, and not by way of limitation, a first account 102(1) may transmit a message to a second account, and the social networking system 106 may temporarily store the message in a data store until the second account has viewed or downloaded the message, at which point the social networking system 106 may delete the message from the data store. As another example and not by way of limitation, continuing with the prior example, the message may be stored for a specified period of time (e.g., 2 weeks), after which point the social networking system 106 may delete the message from the data store.

### Privacy Settings for Account-Authentication and Experience-Personalization Information

In particular examples, the social networking system 106 may have functionalities that may use, as inputs, personal or biometric information of a user associated with an account for user-authentication or experience-personalization purposes. An account may opt to make use of these functionalities to enhance their experience on the online social network. As an example, and not by way of limitation, an account may provide personal or biometric information to the social networking system 106. The account’s privacy settings may specify that such information may be used only for particular processes, such as authentication, and further specify that such information may not be shared with any third-party system or used for other processes or applications associated with the social networking system 106. As another example and not by way of limitation, the social networking system 106 may provide a functionality for an account to provide voice-print recordings to the online social network. As an example, and not by way of limitation, if an account wishes to utilize this function of the online social network, the user associated with the account may provide a voice recording of his or her own voice to provide a status update on the online social network. The recording of the voice-input may be compared to a voice print of the user associated with the account to determine what words were spoken by the account. The account’s privacy setting may specify that such voice recording may be used only for voice-input purposes (e.g., to authenticate the account, to send voice messages, to improve voice recognition in order to use voice-operated features of the online social network), and further specify that such voice recording may not be shared with any third-party system or used by other processes or applications associated with the social networking system 106. As another example and not by way of limitation, the social networking system 106 may provide a functionality for an account to provide a reference image (e.g., a facial profile, a retinal scan) to the online social network. The online social network may compare the reference image against a later-received image input (e.g., to authenticate the account, to tag the account in photos). The account’s privacy setting may specify that such voice recording may be used only for a limited purpose (e.g., authentication, tagging the account in photos), and further specify that such voice recording may not be shared with any third-party system or used by other processes or applications associated with the social networking system 106.

### Account-Initiated Changes to Privacy Settings

In particular examples, changes to privacy settings may take effect retroactively, affecting the visibility of objects and content shared prior to the change. As an example, and not by way of limitation, a first account 102(1) may share a first image and specify that the first image is to be public to all other accounts. At a later time, the first account 102(1) may specify that any images shared by the first account 102(1) should be made visible only to a group associated with the first account 102(1). The social networking system 106 may determine that this privacy setting also applies to the first image and make the first image visible only to the first account’s 102(1) group. In particular examples, the change in privacy settings may take effect only going forward. Continuing the example above, if the first account 102(1) changes privacy settings and then shares a second image, the second image may be visible only to the first account’s 102(1) group, but the first image may remain visible to all accounts. In particular examples, in response to an account action to change a privacy setting, the social networking system 106 may further prompt the account to indicate whether the account wants to apply the changes to the privacy setting retroactively. In particular examples, an account change to privacy settings may be a one-off change specific to one object. In particular examples, an account change to privacy may be a global change for all objects associated with the account.

In particular examples, the social networking system 106 may determine that a first account 102(1) may want to change one or more privacy settings in response to a trigger action associated with the first account 102(1). The trigger action may be any suitable action on the online social network. As an example, and not by way of limitation, a trigger action may be a change in the relationship between a first and second account of the online social network (e.g., “un-friending” an account, changing the relationship status between the accounts). In particular examples, upon determining that a trigger action has occurred, the social networking system 106 may prompt the first account 102(1) to change the privacy settings regarding the visibility of objects associated with the first account 102(1). The prompt may redirect the first account 102(1) to a workflow process for editing privacy settings with respect to one or more entities associated with the trigger action. The privacy settings associated with the first account 102(1) may be changed only in response to an explicit input from the first account 102(1) and may not be changed without the approval of the first account 102(1). As an example and not by way of limitation, the workflow process may include providing the first account 102(1) with the current privacy settings with respect to the second account or to a group of accounts (e.g., un-tagging the first account 102(1) or second account from particular objects, changing the visibility of particular objects with respect to the second account or group of accounts), and receiving an indication from the first account 102(1) to change the privacy settings based on any of the methods described herein, or to keep the existing privacy settings.

In particular examples, an account may need to provide verification of a privacy setting before allowing the account to perform particular actions on the online social network, or to provide verification before changing a particular privacy setting. When performing particular actions or changing a particular privacy setting, a prompt may be presented to the account to remind the account of his or her current privacy settings and to ask the account to verify the privacy settings with respect to the particular action. Furthermore, an account may need to provide confirmation, double-confirmation, authentication, or other suitable types of verification before proceeding with the particular action, and the action may not be complete until such verification is provided. As an example, and not by way of limitation, an account’s default privacy settings may indicate that a person’s relationship status is visible to all accounts (i.e., “public”). However, if the account changes his or her relationship status, the social networking system 106 may determine that such action may be sensitive and may prompt the account to confirm that his or her relationship status should remain public before proceeding. As another example and not by way of limitation, an account’s privacy settings may specify that the account’s posts are visible only to friends of the account. However, if the account changes the privacy setting for his or her posts to being public, the social networking system 106 may prompt the accounts with a reminder of the account’s current privacy settings of posts being visible only to friends, and a warning that this change will make all of the account’s past posts visible to the public. The account may then be required to provide a second verification, input authentication credentials, or provide other types of verification before proceeding with the change in privacy settings. In particular examples, an account may need to provide verification of a privacy setting on a periodic basis. A prompt or reminder may be periodically sent to the account based either on time elapsed or a number of account actions. As an example, and not by way of limitation, the social networking system 106 may send a reminder to the account to confirm his or her privacy settings every six months or after every ten photo posts. In particular examples, privacy settings may also allow accounts to control access to the objects or information on a per-request basis. As an example, and not by way of limitation, the social networking system 106 may notify the account whenever a third-party system attempts to access information associated with the account and require the account to provide verification that access should be allowed before proceeding.

### EXAMPLE USER INTERFACES

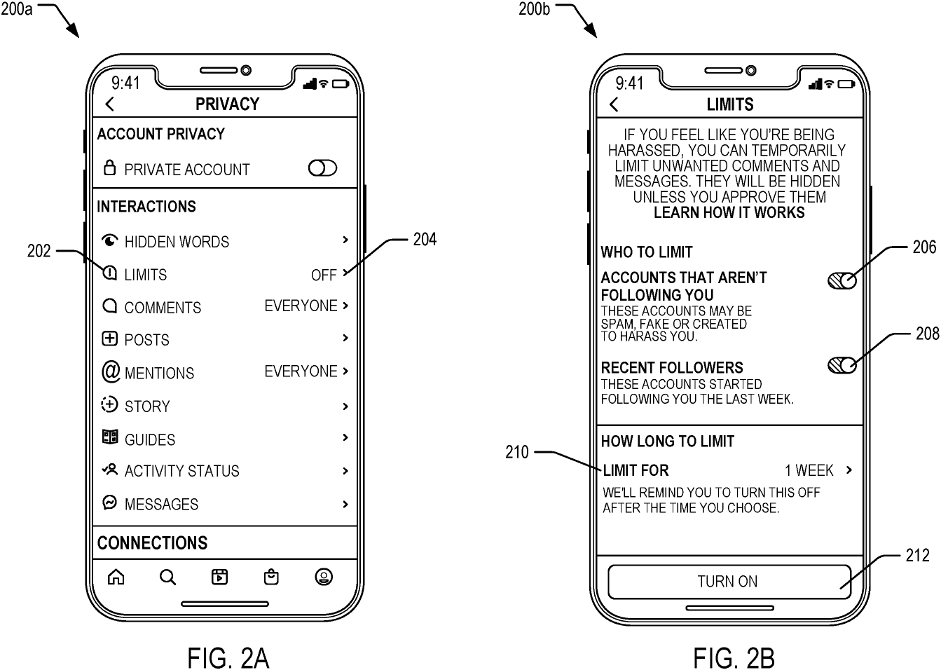

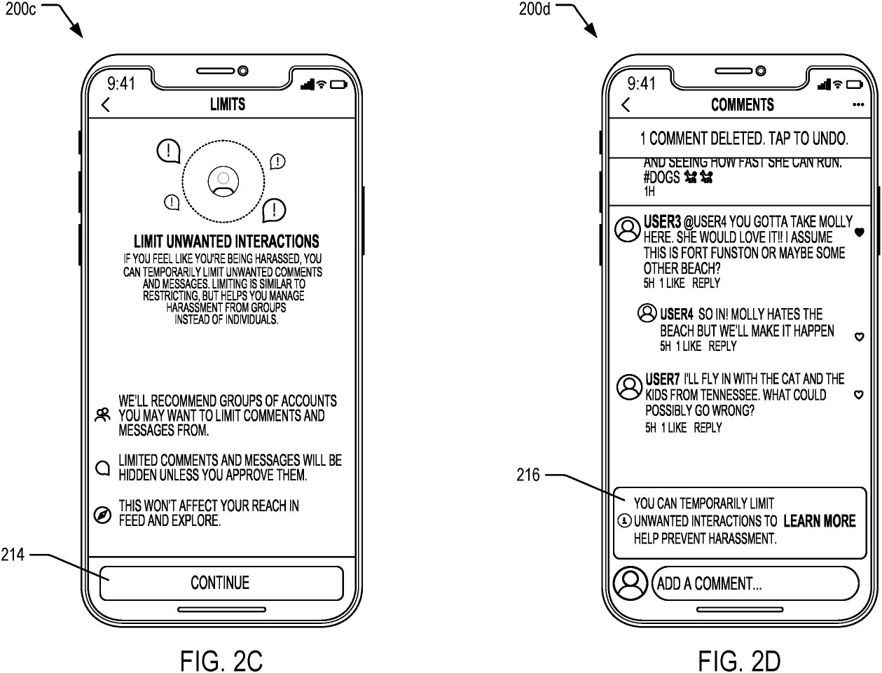

FIG. 2A-FIG. 5C are schematic views showing example user interfaces that are usable to implement the techniques described herein for limiting sharing of comments by accounts lacking a characteristic.. The interfaces and/or the notifications may be generated by a computing device of a social networking system (e.g., social networking system 106) and transmitted to one or more user computing devices (e.g., computing devices 104) for presentation, and/or the interfaces may be generated by the one or more user computing devices based at least in part on instructions received from the social networking system 106. As discussed above, the interfaces described in this section may, but need not, be implemented in the context of the computing system 100.

FIGS. 2A-2D illustrate example interfaces for limiting sharing of comments by an account lacking a characteristic. For example, as shown in FIG. 2A, the first account 102(1) may access a privacy setting interface, as depicted by user interface 200a. The user interface 200a may include a “limits” selectable control 202. In the current example, the limits control is turned off, as indicated by the “OFF” icon 204. Upon selection of the limits selectable control 202, the first account 102(1) may access a “limits” user interface 200b, which may include selectable controls to allow the first account 102(1) to limit unwanted comments from other accounts.

The “limits” user interface 200b may include various selectable controls which may allow the first account 102(1) to customize their ability to limit other accounts from commenting on the first account’s 102(1) content. For example, the limit user interface may include a selectable control 206, which, upon selection, allows the first account to limit accounts that are not following the first account 102(1). Thus, upon selection of the selectable control 206, a comment received from an account who is not a follower of the first account 102(1) will be refrained from being shared with additional accounts, while a comment received from an account who is a follower of the first account 102(1) may be shared with the additional accounts.

The “limits” user interface 200b may also include a selectable control 208, which, upon selection, may allow the first account to limit accounts that are not recent followers of the first account 102(1). For example, upon selection of the control 208, the social networking system 106 may determine a length of time a second account 102(2) has been a follower of the first account 102(1) (e.g., one day, five days, one week, one month, one year, etc.). Based in part on the length of time the second account 102(2) has followed the first account 102(1) being greater than or equal to a threshold amount of time (e.g., one day, one week, one month, one year, two years, etc.), the social networking system 106 may determine that the second account 102(2) is not a recent follower, thus not restricting comments by the second account 102(2) on the first account’s 102(1) content. Conversely, the social networking system 106 may determine that the length of time the second account 102(2) has followed the first account 102(1) is less than the threshold period of time, the social networking system 106 may determine that the second account 102(2) is a recent follower of the first account 102(1), thus refraining form sharing comments by the second account 102(2) associated with the first account’s 102(1) content.

In other words, upon selection of the selectable control 206, a comment received from an account who is not a follower of the first account 102(1) may be refrained from being shared with additional accounts, while a comment received from an account who is a follower of the first account 102(1) may be shared with additional accounts.

As depicted in the “limits” user interface 200b, both selectable controls 206 and 208 are turned on, indicating that the first account 102(1) has chosen to refrain from sharing comments by accounts who are not following the first account 102(1) or who have been following the first account 102(1) for less than a week. While the current example defines a recent follower as an account who has followed the first account 102(1) for one week or longer, any length of time may be used. For example, the first account may determine that a recent follower is defined as an account following the first account for less than a year. Additionally, other characteristics may be used to determine whether the social networking system 106 may share the other account’s comment. This may include, for example, a number of followers of the other account, a number of interactions between the other account and the first account 102(1), or whether the other account is a verified account, to name a few non-limiting examples.

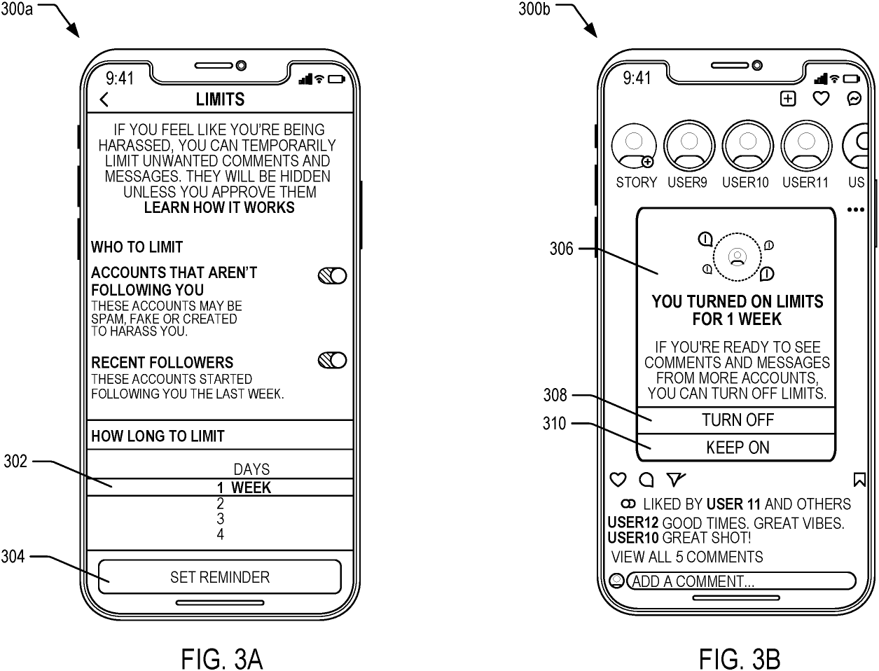

In some examples, the limits user interface 200(b) may include selectable control 210, which may allow the first account 102(1) to limit the ability of accounts lacking the characteristic from commenting on the content for a period of time. This feature is described in more detail in FIGS. 3A and 3B, below.

In some examples, the “limits” user interface 200b may include a selectable control 212 which may allow the first account 102(1) to turn on selectable controls 206 and/or 208. Further, selection of the selectable control 212 may save the first account’s selections regarding limiting accounts. However, in some examples, selecting the selectable controls 206 and/or 208 may save the first account’s 102(1) preferences.

In some examples, the social networking system 106 may determine that the first account 102(1) may be subject to mass harassment and may prompt the first account 102(1) to limit comments from some accounts. FIG. 2C illustrates an example user interface 200c which contains a selectable control 214 that, upon selection, may bring the first account to the “limits” user interface 200b. In some examples, the social networking system 106 may include a machine-learned model 114 which may determine that the content and/or the first account 102(1) may be subject to mass harassment, allowing the first account 102(1) to take proactive measures to prevent such mass harassment from occurring. This determination may be based in part on the first account 102(1) and/or the content, and whether the first account 102(1) has already shared the content to the social networking system 106.

The user interface 200c may be presented to the first account 102(1) in a variety of scenarios. For instance, the first account 102(1) may have requested to post content but has yet to share the content with the other accounts of the social networking system 106. The machine-learned model 114 may determine the first account 102(1) may encounter mass harassment based in part on a number of followers of the first account 102(1). For example, the machine-learned model 114 may determine a number of followers of the first account 102(1) (e.g., 500 followers, 1000 followers, 5000 followers, 100k followers, 1 million followers, 5 million followers, etc.). Based in part on the number of followers being greater or equal to the threshold number of followers (e.g., 1000 followers, 500k followers, 1 million followers, 2 million followers, etc.), the machine-learned model 114 may determine that the first account 102(1) is likely to experience mass harassment.

In some examples, the machine-learned model 114 may determine the first account 102(1) may be subject to mass harassment based in part on an increased rate of change of followers. For example, the machine-learned model 114 may determine a historical average rate of change of followers of the first account 102(1). The average rate of change of followers may represent the percent increase or decrease of new followers of the first account 102(1) over a period of time. As such, the historical average rate of change of followers may represent the percent increase or decrease of followers of the first account 102(1) over a period of time the first account 102(1) has been active (e.g., past 6 months, past 1 year, past 2 year, etc.). The machine-learned model 114 may then determine a recent average rate of change of followers over a recent period of time (e.g., the past week, the past two weeks, the past month, etc.). The machine-learned model 114 may compare the recent average rate of change of followers to the historical rate of change of followers to determine an overall rate of change of followers. The machine-learned model 114 may compare the overall rate of change of followers to a threshold rate of change of followers (e.g., +10% increase, +50% increase, +100% increase, +1,000% increase) and upon determining that the overall rate of change of followers exceeds the threshold rate of change of followers, the machine-learned model 114 may determine that the first account 102(1) is likely to experience mass harassment.

In some examples, the machine-learned model 114 may analyze content that has already been posted by the first account 102(1) to the social networking system, as illustrated in user interface 200d. For example, the machine-learned model 114 may determine a historical average rate of change of engagement with the content. The average historical rate of change of engagement may be based in part on the number of likes, comments, saves, or shares of the content, to name a few non-limiting examples, over a period of time the content has been posted to the social networking system (e.g., one hour, six hours, one day, one week, etc.). The machine-learned model may then determine a recent rate of change of engagement over a recent period of time (e.g., the past 10 minutes, the past 30 minutes, the past hour, the past day, etc.). The machine-learned model 114 may compare the recent average rate of change of followers to the historical rate of change of followers to determine an overall rate of change of followers. The machine-learned model 114 may then compare the overall rate of change of engagement to a threshold rate of change of engagement (e.g., +10% increase, +50% increase, 100% increase, 1,000% increase) and upon determining that the overall rate of change of engagement exceeds the threshold rate of change of engagement, the machine-learned model 114 may determine that the content posted by the first account 102(1) is likely to experience mass harassment.

In some examples, the first account 102(1) may be prompted by the social networking system 106 to limit comments based in part on actions taken by the first account. For example, the social networking system 106 may receive an indication that the first account 102(1) has deleted a comment. Based at least on receiving the indication, the social networking system may determine that the first account may be experiencing harassment and may present selectable control 216 to the first account.

FIGS. 3A and 3B illustrate example interfaces usable to determine a period of time for which to limit sharing of comments by an account lacking a characteristic. FIG. 3A illustrates an example user interface, similar to the “limits” user interface 200a, in which the first account 102(1) may determine a period of time to limit accounts lacking a characteristic from commenting on the content. Due to the fast pace of social media, controversial content may experience a brief and rapid wave of mass harassment initially after posting the content. However, as other accounts post other content, the chance that the first account 102(1) may experience mass harassment regarding the first account’s 102(1) content may decrease. Additionally, the first account 102(1) may not wish to permanently limit the ability for accounts to comment and interact with the content; rather, the first account 102(1) may wish just to curb initial harassment following posting the content.

As such, the social networking system 106 may provide the first account 102(1) the option to temporarily limit accounts lacking a characteristic from commenting on the content. For example, the first account 102(1) may be presented the selectable control 302 in which the first account 102(1) may determine a period of time to limit comments (e.g., one day, five days, one week, two weeks, etc.). Additionally, the first account 102(1) may, upon selection of selectable control 304, set a reminder.

In some examples, as illustrated by user interface 300b in FIG. 3B, the social networking system 106 may present a notification 306 to the first account 102(1) reminding the first account 102(1) that the they limited the ability for accounts lacking a characteristic to comment on the content for a period of time. The notification may be presented to the first account 102(1) prior to the period of time expiring, once the period of time has expired, and/or after the period of time has expired. The notification 306 may, in some examples, include selectable controls 308 and/or 310. For example, selection of the control 308 may enable the first account 102(1) to keep or turn the “limits” feature off, thus allowing accounts having a characteristic to comment on the first user’s 102(1) content. Conversely, selection of the control 308 may enable the first account 102(1) to turn the limits feature back on, continuing to limit the ability for accounts lacking a characteristic to comment on the first user’s 102(1) content. In some examples, upon selection of the selectable control 310, the first account 102(1) may be presented with the user interfaces 200a and/or 300a.

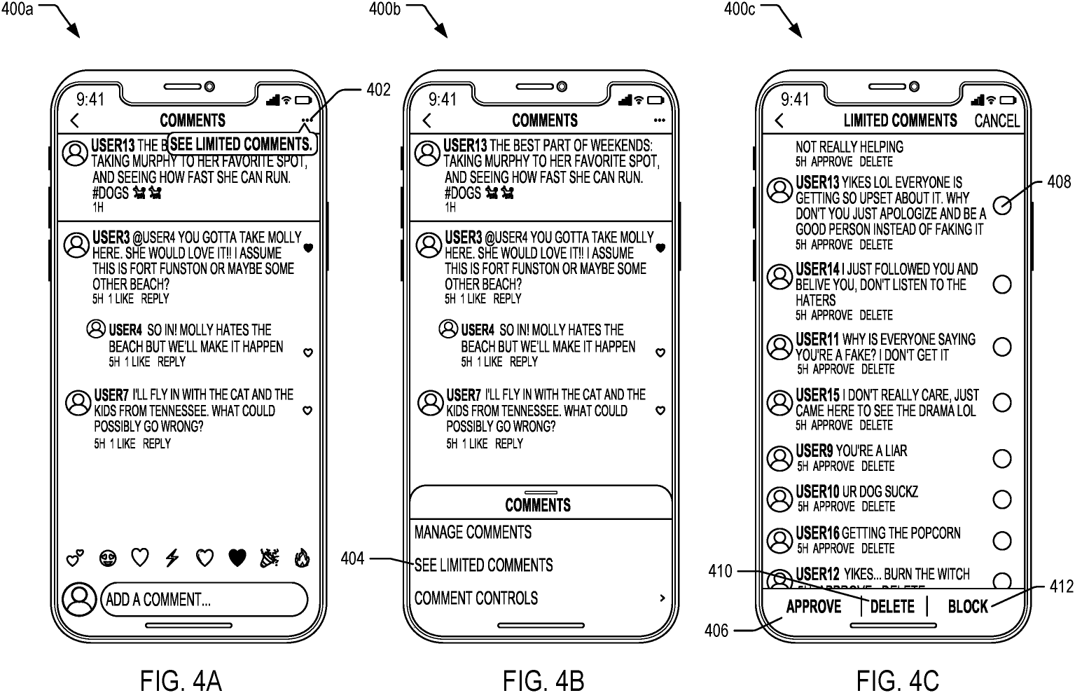

FIGS. 4A-4C illustrate example interfaces usable to present selectable controls to approve and delete comments on a post and block accounts. FIG. 4A illustrates an example user interface 400a for accessing controls usable to manage comments by accounts lacking a characteristic. For example, upon selection of selectable control 402, the first account 102(1) may be presented user interface 400b, as illustrated in FIG. 4B. The user interface 400b may include selectable control 404 which, upon selection, may allow the first account 102(1) to view comments by accounts that lack a characteristic. In some examples, the comment may be located in a quarantine interface, as depicted in user interface 400c in FIG. 4C.

In some instances on the interface of the first account 102(1), the comment by the user lacking the characteristic may be placed in a serrate location (e.g., a quarantine interface) such that the comment is not presentenced with other comments associated with the content. Instead, in that case, the first account 102(1) may choose when or if to access comments in the quarantine location. However, in some instances, the comment may still be visible to the account who posted the comment.

In some examples, the first account 102(1) may choose to approve or delete comments associated with the content. For instance, upon selecting the selectable control 404 to view limited comments, the first account 102(1) may be presented with selectable control 406 to approve a comment posted by a second account 102(2). In some examples, the first account may select a selectable control 408 associated with a comment. Once the comment has been selected, the first account 102(1) may choose to approve or delete the comment. Upon selecting the control associated with approving the comment, the comment may be accessible for the additional accounts to view. Conversely, upon selecting a control 410 associated with deleting the comment, the comment may be refrained from being shared with the additional accounts. In some examples, upon deleting the comment, the second account 102(2) may still view the comment, while in other examples, deleting the comment may remove the comment from the second account’s 102(2) view. Furthermore, the deletion may be permanent; however, in other examples, the first account 102(1) may later choose to approve the comment.

In some examples, the first account 102(1) may choose to block an account associated with the comment. For instance, once the first account 102(1) has selected a comment, the first account 102(1) may select a selectable control 412 associated with blocking the account associated with the comment. The social networking system 106 may, in some examples, then refrain from sharing future comments by the account associated with the content and/or any future comment directed toward the first account 102(1). Furthermore, the block may be permanent; however, in other examples, the first account 102(1) may later choose to unblock the account, allowing the account to share future comments.

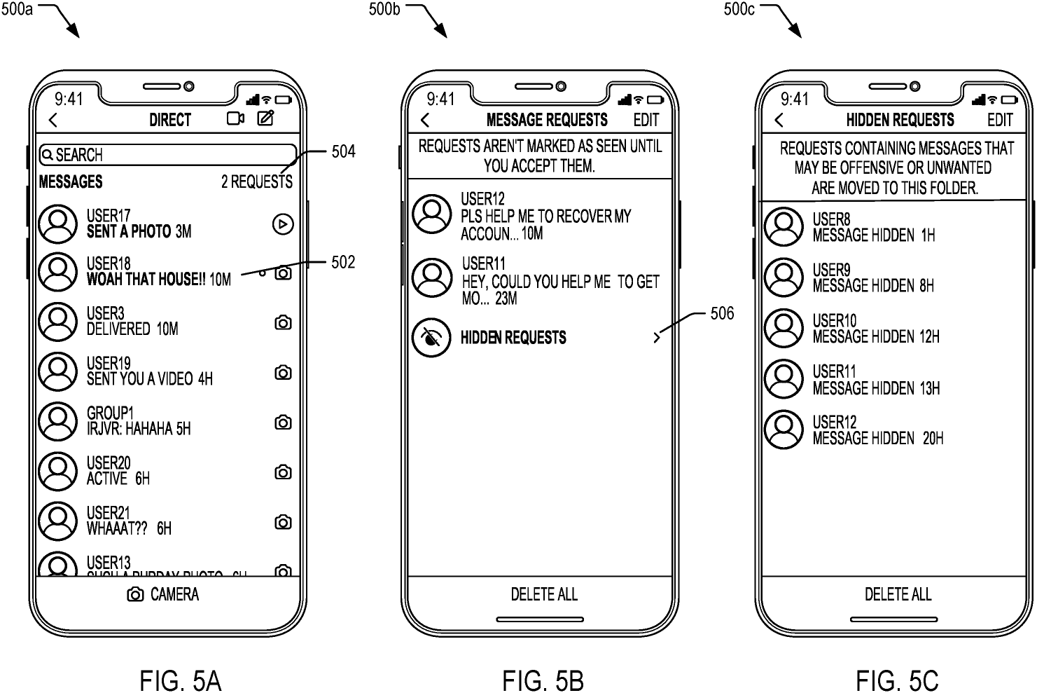

FIGS. 5A-5C illustrate example interfaces usable to view a quarantine interface of comments received from accounts lacking the characteristic. FIG. 5A illustrates an example user interface 500a depicting an inbox of the first account 102(1). For example, an account may send the first account 102(1) a direct message 502, which may appear in the inbox. In some examples, the social networking system may display in the inbox messages that have been sent by a follower of the first account 102(1), while messages received by non-followers of the first account 102(1) may be located in a messages request interface. In some examples, the social networking system 106 may present to the first account 102(1) a selectable control 504 indicating the number of messages from non-followers.

Upon selection of the selectable control 504, the social networking system 106 may present the message request interface 500b, as depicted in FIG. 5B, to the first account 102(1). In some examples, the message request interface may include messages sent to the first account 102(1) from other accounts who are non-followers of the first account 102(1). However, in some examples, the social networking system may detect that some messages may include harmful or harassing content. Thus, the social networking system may direct these harassing messages to a quarantine interface, similar to that described with respect to FIGS. 4. In some examples, the message request interface 500b may include selectable control 506 which may direct the first account 102(1) to a quarantine interface 500c, as depicted in FIG. 5C. In some examples, the first account 102(1) may approve or delete messages or block accounts, similar to that described in FIG. 4C.

### Example Methods

Various methods are described with reference to the example system of FIG. 1 for convenience and ease of understanding. However, the methods described are not limited to being performed using the system of FIG. 1 and may be implemented using systems and devices other than those described herein.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the method may be omitted entirely. Moreover, the methods described herein can be combined in whole or in part with each other or with other methods.

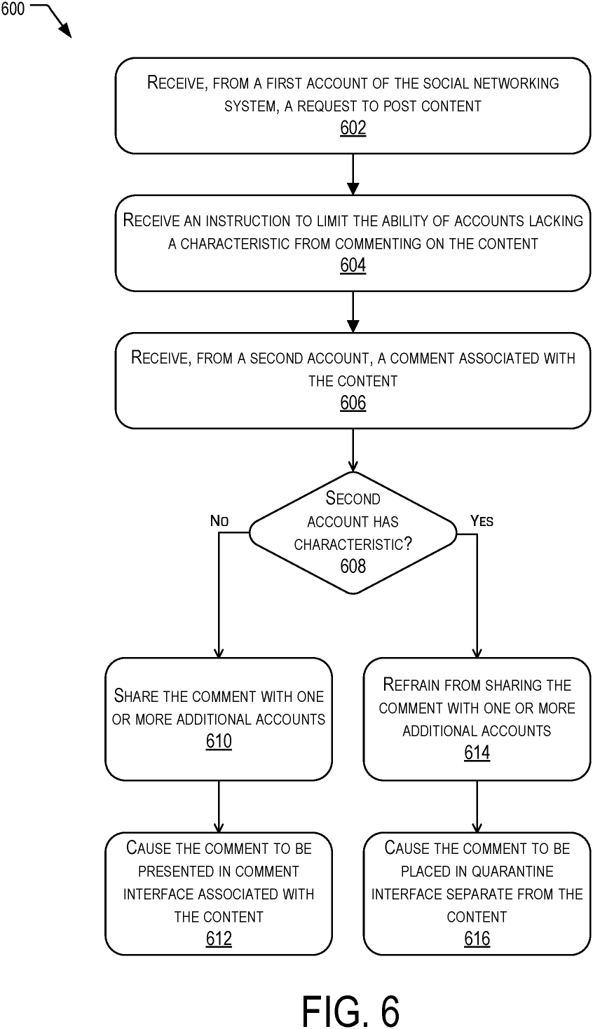

FIG. 6 depicts an example process 600 for limiting the ability for accounts lacking a characteristic to comment on content from a first account.

At operation 602, the process may include receiving, from a first account of the social networking system, a request to post content. Content may take a variety of forms, such as a profile or feed post, a story, a direct message to one or more other users, a tweet, or a snap, to name a few examples.

At operation 604, the process may include receiving an instruction to limit the ability of accounts lacking the characteristic from commenting on the content. The characteristic may, in some examples, be indicative of whether another account is likely to post an offensive or harassing comment on the content, subjecting the first account to harassment. In some cases, the characteristic may be based upon the other account being a follower of the first account or the other account following the first account for a threshold period of time (e.g., 1 day, 5 days, 1 week, 1 month, etc.). In some examples, the social networking system may receive the instruction from a machine-learned model trained to detect content that is likely to encounter mass harassment. In some cases, the machine-learned model may determine that the content and/or the first account may be subject to or is experiencing mass harassment, allowing the first account to take proactive measures to prevent such mass harassment from occurring or stop further harassment.

At operation 606, the process may include receiving, from a second account, a comment associated with the content. Similar to the content, the comment may be a response to a profile or feed post, a response to a story, or a direct message response, to name a few non-limiting examples.

At operation 608, the process may include determining whether the second account has the characteristic. Additionally or alternatively, the social networking system may determine that the content and/or the first account is currently experiencing, or is predicted to experience, mass harassment. The social networking system may prompt the first account to take proactive measures to prevent such mass harassment from occurring or stop further harassment. In some examples, the social networking system may employ one or more algorithms, filters, or models to identify potentially controversial content (e.g., content associated with religion, politics, etc.). The algorithms, filters, or models may be based on text, audio, and/or video of the content. In some examples, the social networking system may employ a machine-learned model trained to detect content that is likely to encounter mass harassment.

At operation 610, upon determining that the second account does not have the characteristic (indicated by “NO”), the process may include sharing the comment with one or more additional accounts. For example, based in part on determining that the second account does not have the characteristic, the social networking system may determine that the comment is likely not mass harassment.

At operation 612, the process may include causing the comment ot be presented in a comment interface associated with the content. For example, the comment may be presented, both to the first user and to one or more additional accounts. In some cases, the one or more additional accounts may interact with the comment, such as liking it or responding to it.

At operation 614, upon determining that the second account does have the characteristic (indicated by “YES”), the process may include refraining from sharing the comment with the one or more additional accounts. For example, upon accessing the content, the other accounts may not be able to see and/or interact with the comment by the second account. However in some instances, the comment may still be visible to the second account.

At operation 616, the process may include causing the comment to be placed in a quarantine interface separate from the content. For example, the comment may be placed in a separate location such that the comment is not presented with other comments associated with the content. Instead, in that case, the user of the first account may choose when or if to access comments in the quarantine location. However, in some instances, the comment may still be visible to the second account (e.g., the fact that the comments have been limited by the first account may not be visible to the second account).

### Example System and Device

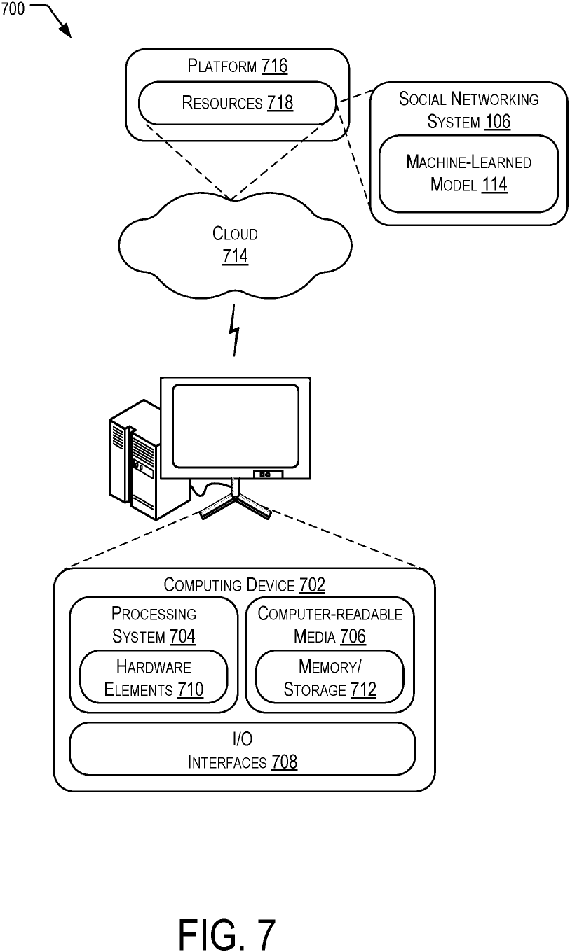

FIG. 7 illustrates an example system generally at 700 that includes an example computing device 702 that is representative of one or more computing systems and/or devices that may implement the various techniques described herein. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage component 712. The memory/storage component 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 702. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 702, such as via a network. Computer-readable transmission media typically may transmit computer-readable instructions, data structures, program modules, or other data in a modulated data signal, such as carrier waves, data signals, or other transport mechanism. Computer-readable transmission media also include any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 710 and computer-readable media 706 are representative of modules, programmable device logic and/or device logic implemented in a hardware form that may be employed in some examples to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also be scalable to provide a corresponding level of scale to encountered demand for the resources 718 that are implemented via the platform 716. Accordingly, in an interconnected device embodiment, implementation of functionality described herein may be distributed throughout multiple devices of the system 700. For example, the functionality may be implemented in part on the computing device 702 as well as via the platform 716 which may represent a cloud computing environment 714.

The example systems and methods of the present disclosure overcome various deficiencies of known prior art devices. Other examples of the present disclosure will be apparent to those skilled in the art from consideration of the specification and practice of the disclosure contained herein. It is intended that the specification and examples be considered as example only, with a true scope and spirit of the present disclosure being indicated by the following claims.

### Conclusion

Although the discussion above sets forth example implementations of the described techniques, other architectures may be used to implement the described functionality, and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a first account of a social networking system, a request to post content;
receiving, from the first account, an instruction to limit an ability of accounts lacking a characteristic from commenting on the content;
receiving, from a second account, a comment associated with the content;
determining that the second account lacks the characteristic, and
based at least in part on determining that the second account lacks the characteristic, refraining from sharing the comment with one or more additional accounts.

2. The method of claim 1, wherein the comment is a first comment, the method further comprising:
receiving, from a third account which has the characteristic, a second comment associated with the content; and
sharing the second comment with the one or more additional accounts.

3. The method of claim 1, wherein the characteristic includes following the first account for a period of time greater than a threshold period of time.

4. The method of claim 1, wherein the instruction to limit the ability of accounts lacking a characteristic from commenting on the content is for a specified period of time.

5. (canceled)

6. The method of claim 1, wherein the instruction to limit the ability of accounts lacking the characteristic from commenting on the content is received from the social networking system and based at least in part on at least one of:
an offensiveness of the comment or another comment;
a number of comments associated with the content;
a number of followers of the first account; or
a rate of increase in followers of the first account.

7. The method of claim 1, further comprising refraining from presenting the comment to the first account in association with the content; and
sending the comment to a quarantine interface accessible by the first account, the quarantine interface being separate from other comments associated with the content.

8. The method of claim 1, further comprising:
presenting, to the first account, a control associated with at least approving or deleting the comment; and
at least one of:
based at least in part on receiving input via the control approving the comment, sharing the comment with the one or more additional accounts; or
based at least in part on receiving input via the control deleting the comment, refraining from sharing the comment with the one or more additional accounts.

9. The method of claim 1, further comprising:
presenting, to the first account, a control associated with blocking the comment; and
based at least in part on receiving input via the control blocking the comment, refraining from sharing additional comments by the second account with the one or more additional accounts.

10. The method of claim 1, wherein the comment is a first comment, the method further comprising:
receiving, from the second account, a second comment associated with the content originating from the first account, the second comment in response to the first comment;
receiving, from the first account, an indication to approve the second comment; and
sharing, based at least in part on the indication to approve the second comment, the second comment with one the one or more additional accounts;
wherein sharing the second comment shares at least a portion of the first comment with the one or more additional accounts.

11. The method of claim 1, wherein the content comprises at least a portion of a profile post, a story, or a direct message.

12. A system comprising:
one or more processors; and
computer-readable media storing instructions that, when executed by the one or more processors, cause the system to perform operations comprising:
receiving, from a first account of a social networking system, a request to post content;
receiving, from the first account, an instruction to limit an ability of accounts lacking a characteristic from commenting on the content;
receiving, from a second account, a comment associated with the content;
determining that the second account lacks the characteristic, and
based at least in part on determining that the second account lacks the characteristic, refraining from sharing the comment with one or more additional accounts.

13. The system of claim 12, wherein the comment is a first comment, the operations further comprising:
receiving, from a third account which has the characteristic, a second comment associated with the content; and
sharing the second comment with the one or more additional accounts.

14. The system of claim 12, wherein the characteristic includes following the first account for a period of time greater than a threshold period of time.

15. The system of claim 12, wherein the instruction to limit the ability of accounts lacking a characteristic from commenting on the content is for a specified period of time.

16. The system of claim 12, further comprising refraining from presenting the comment to the first account in association with the content; and
sending the comment to a quarantine interface accessible by the first account, the quarantine interface being separate from other comments associated with the content.

17. One or more non-transitory computer-readable media storing instructions that, when executed by one or more processors of a server computing device, cause the server computing device to perform operations comprising:
receiving, from a first account of a social networking system, a request to post content;
receiving, from the first account, an instruction to limit an ability of accounts lacking a characteristic from commenting on the content;
receiving, from a second account, a comment associated with the content;
determining that the second account lacks the characteristic, and
based at least in part on determining that the second account lacks the characteristic, refraining from sharing the comment with one or more additional accounts.

18. (canceled)

19. The one or more non-transitory computer-readable media of claim 17, wherein the comment is a first comment, the operations further comprising:
receiving, from the second account, a second comment associated with the content originating from the first account, the second comment in response to the first comment;
receiving, from the first account, an indication to approve the second comment; and
sharing, based at least in part on the indication to approve the second comment, the second comment with one the one or more additional accounts;
wherein sharing the second comment shares at least a portion of the first comment with the one or more additional accounts.

20. The one or more non-transitory computer-readable media of claim 17, wherein the content comprises at least a portion of a profile post, a story, or a direct message.

21. The system of claim 12, wherein the instruction to limit the ability of accounts lacking the characteristic from commenting on the content is received from the social networking system and based at least in part on at least one of:
an offensiveness of the comment or another comment;
a number of comments associated with the content;
a number of followers of the first account; or
a rate of increase in followers of the first account.

22. The one or more non-transitory computer-readable media of claim 17, the operations further comprising:
presenting, to the first account, a control associated with at least approving or deleting the comment; and
at least one of:
based at least in part on receiving input via the control approving the comment, sharing the comment with the one or more additional accounts; or
based at least in part on receiving input via the control deleting the comment, refraining from sharing the comment with the one or more additional accounts.
